(19) United States
(12) Patent Application Publication
(10) Pub. No.: US 2026/0213423 A1
(43) Pub. Date: Jul. 23, 2026

(54) WIDEBAND RECONFIGURABLE METAMATERIAL SURFACE FOR SPECTRUM SENSING AND BEAMFORMING

(71) Applicant: HEWLETT PACKARD ENTERPRISE DEVELOPMENT LP, Spring, TX (US)

(72) Inventors: SHIVANG AGGARWAL, San Jose, CA (US); Yawen Liu, Spring, TX (US); Mohamed Ahmed, Millburn, NJ (US); Puneet Sharma, Palo Alto, CA (US); Farhan Hasnain, Santa Clara, CA (US); Deven Patel, Santa Clara, CA (US)

(21) Appl. No.: 19/202,487

(22) Filed: May 8, 2025

Related U.S. Application Data
(60) Provisional application No. 63/747,781, filed on Jan. 21, 2025.

(51) Int. Cl. H01Q 15/00; H01Q 21/06

(52) U.S. Cl. CPC H01Q 15/0086; H01Q 21/061

(57) ABSTRACT

Systems and methods are provided for performing frequency conversion using RF metamaterials. An RF metasurface element includes first and second antennas on first and second surfaces, respectively, the first and second surfaces being opposite one another. A modulation signal input is configured to receive a modulation signal. The RF metasurface element is configured to receive, at the first antenna, a first signal having a first frequency. The RF metasurface element is further configured to transmit a second signal at a second, different frequency, from the second antenna, wherein the second frequency is dependent on the first frequency and a frequency of the modulation signal. A plurality of RF metasurface elements may be assembled into an array of elements.

### CROSS REFERENCE TO RELATED APPLICATIONS

This application claims the benefit of and priority to U.S. Provisional Patent Application No. 63/747,781, filed on Jan. 21, 2025, the contents of which are incorporated herein by reference in their entirety.

### BACKGROUND

Reflective radio frequency (RF) metamaterials surfaces are designed to manipulate electromagnetic waves in unique ways. For example, such materials may alter reflectivity properties of incident signals to control aspects such as phase, amplitude, polarization, and in some cases, direction of a reflected signal. Some RF metamaterials may have adjustable resonant frequencies based on various structures implemented thereon.

RF metamaterials may be used in many different applications. For example, in wireless networks, RF metamaterials may be used to optimize indoor signal coverages for indoor wireless networks, for radar cross section reduction, and so on.

### BRIEF DESCRIPTION OF THE DRAWINGS

The present disclosure, in accordance with one or more various examples, is described in detail with reference to the following figures. The figures are provided for purposes of illustration only and merely depict typical, non-limiting aspects of such examples.

FIG. 1 illustrates one example of a network configuration in which examples of the disclosed technology may be implemented.

FIG. 2A is a diagram illustrating an example of a system including an RF metamaterial capable of carrying out frequency conversion of received signals.

FIG. 2B is a flow diagram illustrating an example method of operating a system such as that shown in FIG. 2A.

FIG. 3A is a perspective view of an example RF metamaterial cell used to implement an RF metasurface.

FIG. 3B is an exploded view of an example RF metamaterial cell used to implement an RF metasurface.

FIG. 4 is a top view of an example RF metamaterial cell.

FIG. 5 is a bottom view of an example RF metamaterial cell.

FIGS. 6A-6D are drawings illustrating different possible operating modes for an example RF metamaterial cell.

FIG. 7 is a perspective view illustrating an example system including an RF metamaterial and a modulation signal generator.

FIGS. 8A-8C are illustrations of example use cases for an RF metamaterial system according to the disclosure.

The figures are not exhaustive and do not limit the present disclosure to the precise form disclosed.

### DETAILED DESCRIPTION

Wireless networks are often sensitive to real-world environments where communication links are constrained by RF propagation characteristics and interference. This may be particularly true in indoor environments for, e.g., WiFi networks, but may apply to other wireless networks as well. Problem areas occurring in various wireless networks may include those related to spectrum occupancy detection so as to minimize signal interference, along with the desire for improved coverage range and signal quality given mixed radio types.

One mechanism for dealing with the various issues discussed above is the use of metamaterials, such as RF metasurfaces in wireless networks. Such surfaces may be used to reflect, and therefore redirect signal propagation of wireless signals within a given area. This may in turn allow wireless signals to be directed to an intended receiver. Furthermore, some RF metasurfaces may have the capability of carrying out beamforming functions to further narrow a beam of RF signals, which may increase signal-to-noise ratio at the intended receiver. However, such RF metasurfaces may be constrained to transmitting signals at the same frequency at which they were received.

The present disclosure is directed to an RF metasurface and RF metasurface cells that enable frequency conversion (e.g., similar to that carried out by a mixer of an RF transmitter/receiver). This frequency conversion may be carried out by exploiting a technique known as space-time modulation. The frequency conversion may further rely on controlling parameters (e.g., a resonant frequency) of a receiving antenna on a first surface of RF metasurface cell and on transmitting antenna on a second surface (opposite of the first surface). The cells of the RF metasurface may receive a modulation signal from a modulation signal source. The modulation signal is combined with the received signal, thereby producing an electromagnetic signal (e.g., RF signal) that is transmitted, from the transmitted antenna, at a frequency different than that of the received signal. The cells are also tunable with respect to the resonant frequency of the receiving antenna.

The RF metasurface may additionally be used for beamforming and beam steering to control the directionality of transmitted signals. The beamforming and beam steering may be carried out concurrently with frequency conversion. As a result, the RF metasurface of the present disclosure may allow for more efficient utilization of available spectrum resources and may reduce network congestion in situations where a large number of devices are competing for network bandwidth.

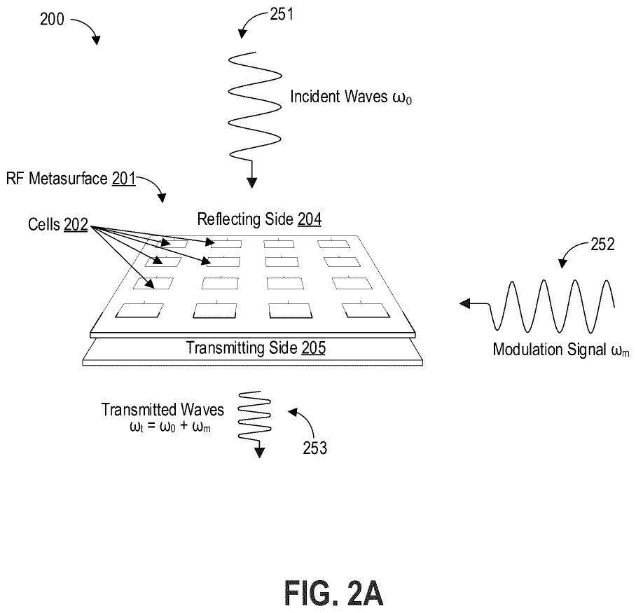

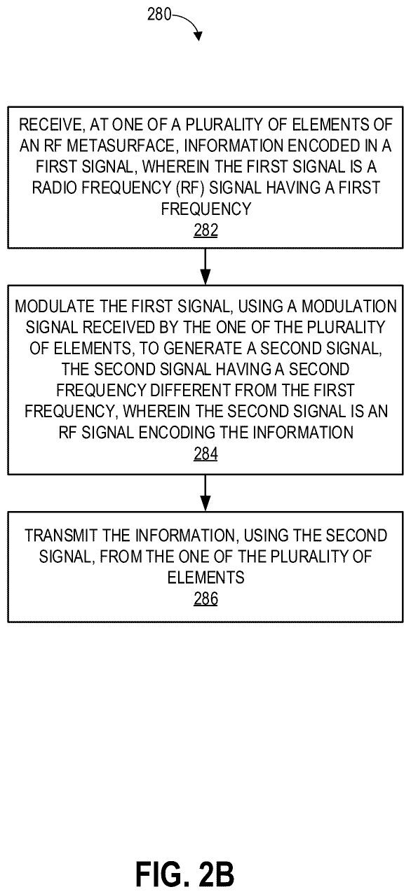

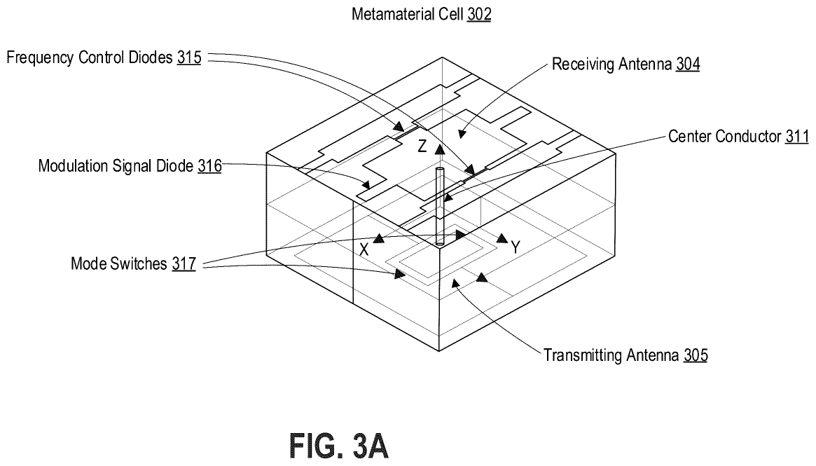

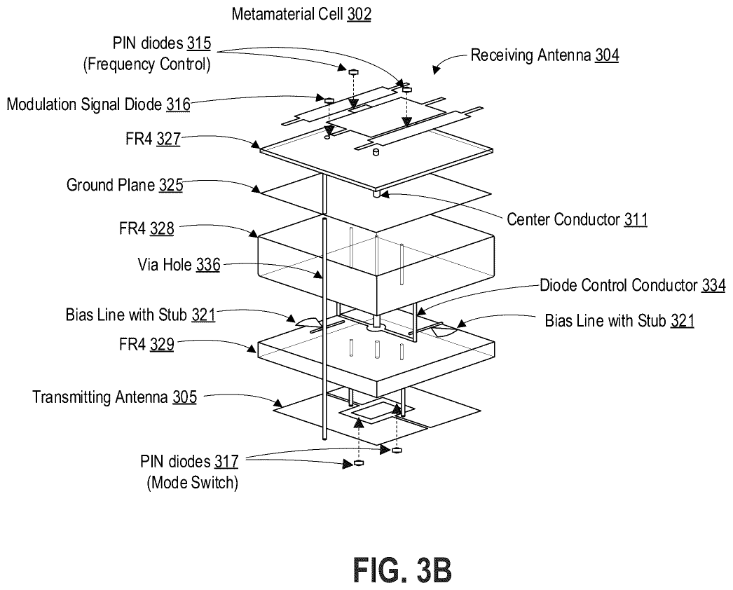

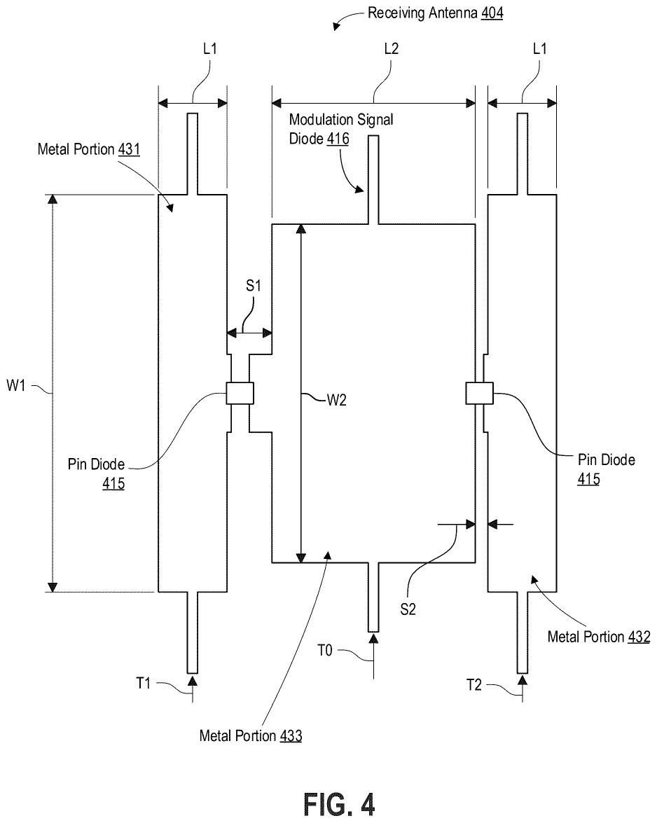

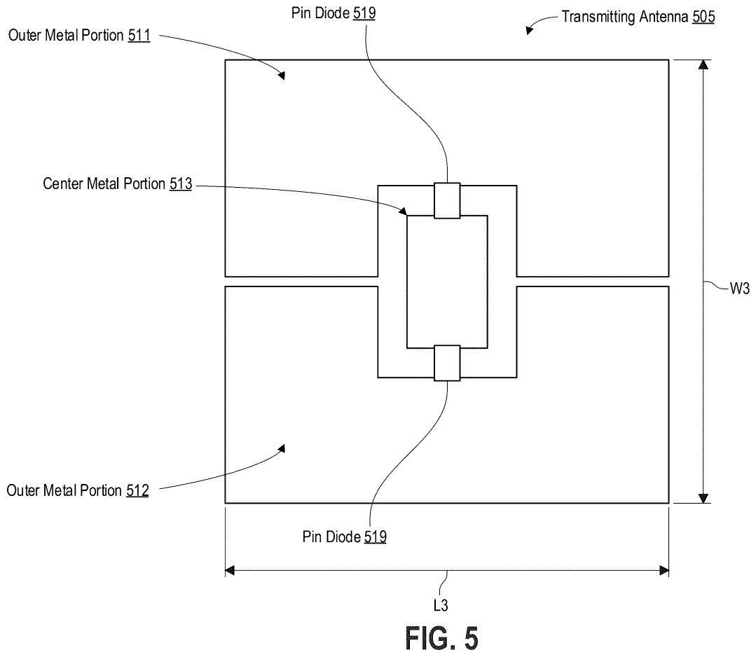

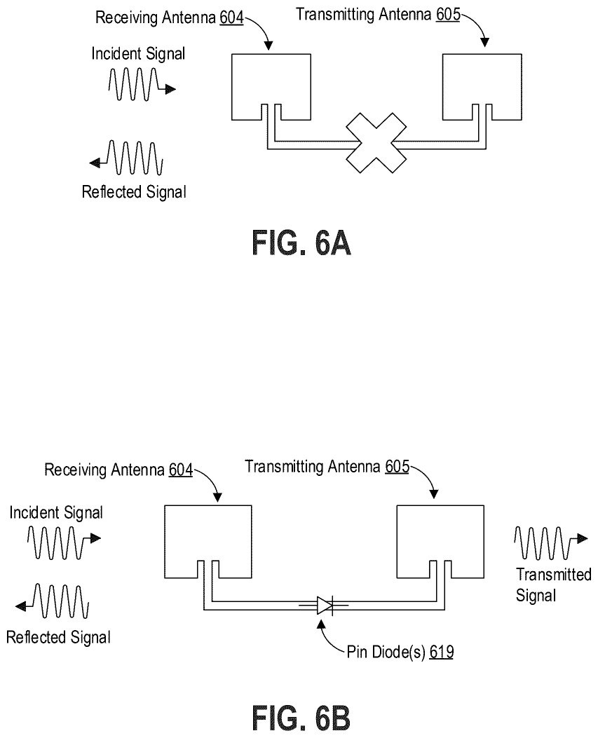

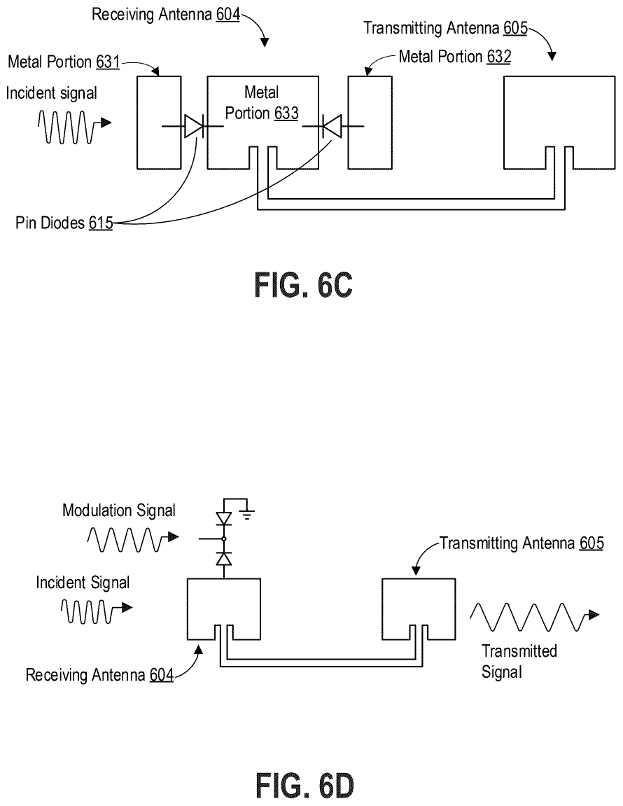

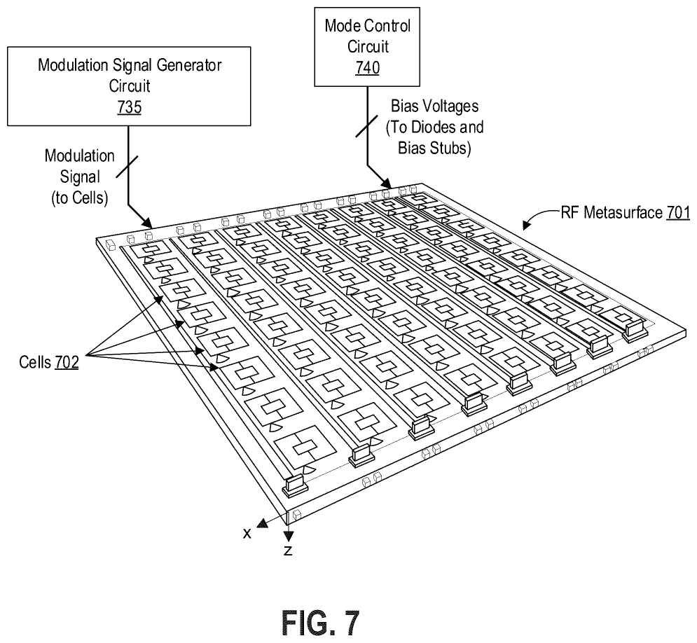

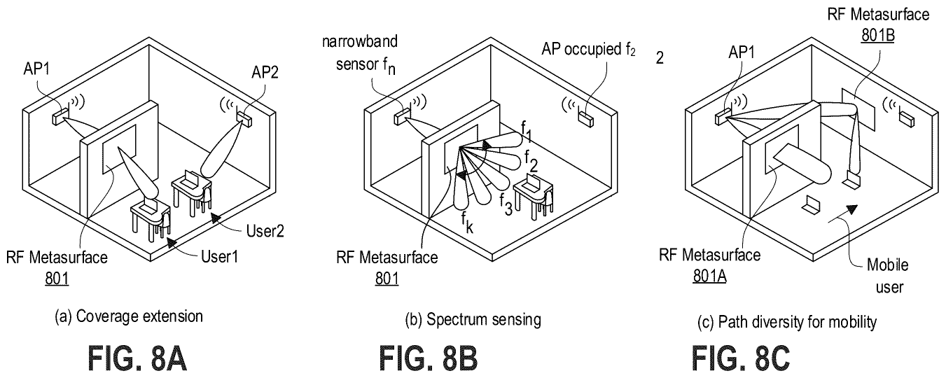

Various implementations of an RF metasurface, cells used in RF metasurfaces, and applications thereof are now discussed in further detail, beginning with a network in which such metasurfaces may be utilized. Thereafter, the use of an RF metasurface for frequency conversion is described with reference to FIGS. 2A and 2B. Construction of one example of a unit cell of an RF metasurface is described with reference to FIGS. 3A and 3B. The descriptions of FIGS. 4 and 5 are directed to receiving and transmitting antennas, respectively, along with an explanation of how frequency conversion may be achieved per the disclosure. Different modes of operation relative to a unit cell of an RF metasurface are discussed with reference to FIGS. 6A-6D. A brief discussion of the components of a system for one implementation of an RF metasurface follows with reference to FIG. 7. Example applications using an RF metasurface with frequency conversion are described with reference to FIGS. 8A-8C.

It should be noted that the terms “optimize,” “optimal” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

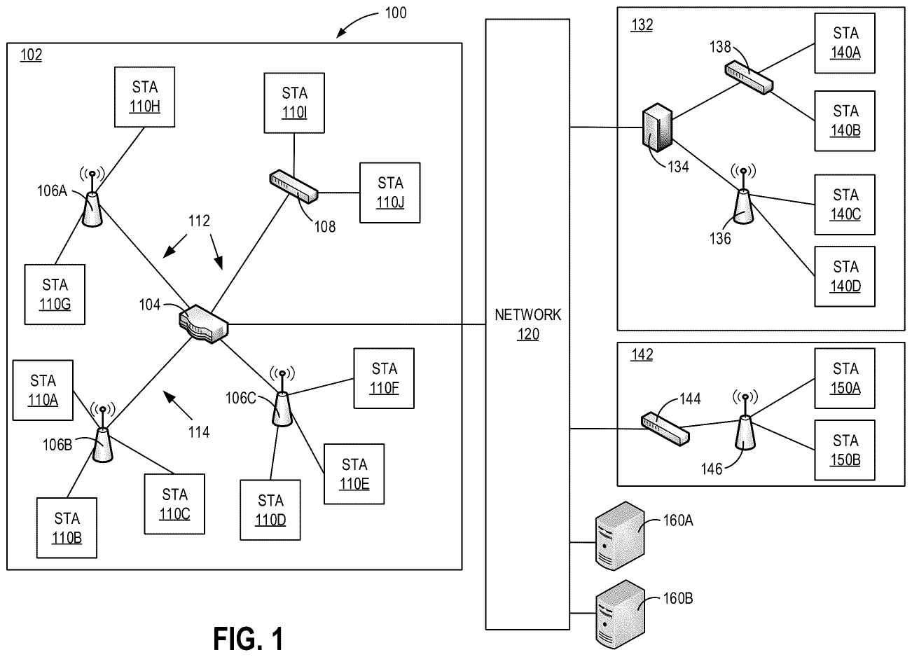

Before describing examples of the disclosed systems and methods in detail, it is useful to describe an example network installation with which these systems and methods might be implemented in various applications. FIG. 1 illustrates one example of a network configuration 100 that may be implemented for an organization, such as a business, educational institution, governmental entity, healthcare facility or other organization. FIG. 1 illustrates an example of a configuration implemented with an organization having multiple users (or at least multiple client devices or stations (STAs) 110, e.g., 110A, 110B, 110C, etc.), and possibly multiple physical or geographical sites 102, 132, 142. Network configuration 100 may include a primary site 102 in communication with a network 120. Network configuration 100 may also include one or more remote sites 132, 142, that are in communication with network 120.

Primary site 102 may include a primary network, which may be an office network, home network, or other network installation, for example. The primary network may be a private network, such as a network that may include security and access controls to restrict access to authorized users of the private network. Authorized users may include employees of a company at primary site 102, residents of a house, customers at a business, for example.

In the example of FIG. 1, primary site 102 includes a controller 104, which is in communication with network 120. Controller 104 may facilitate communication with network 120 for primary site 102. There may be other points of communication with network 120 for primary site 102 in addition to controller 104. Although a single controller 104 is illustrated, the primary site 102 may include multiple controllers or multiple communication points within network 120. In some examples, controller 104 may communicate with network 120 through a router (not illustrated). In other examples, controller 104 provides router functionality to the devices in primary site 102.

Controller 104 may be operable to configure and manage network devices, such as at primary site 102, and may also manage network devices at remote sites 132, 134. Controller 104 may be operable to configure and/or manage switches, routers, access points, and/or client devices connected to a network. Controller 104 may itself be, or provide the functionality of, an access point.

Controller 104 may be in communication with one or more switches 108 or wireless access points (APs) 106A-C. Switches 108 and wireless APs 106A-C provide network connectivity to various client devices or stations (STAs) 110A-J. Using a connection to switch 108 or AP 106A-C, a STA 110A-J may access network resources, including other devices on the (primary site 102) network and network 120.

Examples of client devices may include: desktop computers, laptop computers, servers, web servers, authentication servers, authentication-authorization-accounting (AAA) servers, domain name system (DNS) servers, dynamic host configuration protocol (DHCP) servers, internet protocol (IP) servers, virtual private network (VPN) servers, network policy servers, mainframes, tablet computers, e-readers, netbook computers, televisions and similar monitors (e.g., smart TVs), content receivers, set-top boxes, personal digital assistants (PDAs), mobile phones, smart phones, smart terminals, dumb terminals, virtual terminals, video game consoles, virtual assistants, internet of things (IOT) devices, and the like.

Within primary site 102, switch 108 is included as one example of a point of access to the network established in primary site 102 for STAs 1101-J. STAs 1101-J may connect to switch 108 and through switch 108, may be able to access other devices within network configuration 100. STAs 1101-J may also be able to access network 120 through switch 108. STAs 1101-J may communicate with switch 108 over a wired or wireless 112 connection. In the illustrated example, switch 108 communicates with controller 104 over a wired or wireless 112 connection.

Wireless AP s 106A-C are included as another example of a point of access to the network established in primary site 102 for STAs 110A-H. Each of APs 106A-C may be a combination of hardware, software, and/or firmware that is configured to provide wireless network connectivity to wireless STAs 110A-H. In the example of FIG. 1, APs 106A-C can be managed and configured by controller 104. APs 106A-C communicate with controller 104 and the network over connections 112, which may be either wired or wireless interfaces.

Network configuration 100 may include one or more remote sites 132. A remote site 132 may be located in a different physical or geographical location from primary site 102. In some cases, remote site 132 may be in the same geographical location, or possibly the same building, as primary site 102, but may lack a direct connection to the network located within primary site 102. Instead, remote site 132 may utilize a connection over a different network, e.g., network 120. For example, remote site 132 may be a satellite office, another floor or suite in a building, etc. Remote site 132 may include a gateway device 134 for communicating with network 120. Gateway device 134 may be a router, a digital-to-analog modem, a cable modem, a digital subscriber line (DSL) modem, or some other network device configured to communicate with network 120. Remote site 132 may also include a switch 138 or AP 136 in communication with gateway device 134 over either wired or wireless connections. Switch 138 and AP 136 provide connectivity to the network for various STAs 140A-D.

In various examples, remote site 132 may be in direct communication with primary site 102, such that STAs 140A-D at remote site 132 access the network resources at primary site 102 as if these STAs 140a-d were located at primary site 102. In such examples, remote site 132 is managed by controller 104 at primary site 102, and controller 104 provides the necessary connectivity, security, and accessibility that enable remote site 132's communication with primary site 102. Once connected to primary site 102, remote site 132 may function as a part of a private network provided by primary site 102.

In various examples, network configuration 100 may include one or more smaller remote sites 142, comprising only a gateway device 144 for communicating with network 120, and a wireless AP 146, by which STAs 150A-B access network 120. Such a remote site 142 may represent, for example, an individual employee's home or a temporary remote office. Remote site 142 may also be in communication with primary site 102, such that STAs 150A-B at remote site 142 access network resources at primary site 102 as if these STAs 150A-B were located at primary site 102. Remote site 142 may be managed by controller 104 at primary site 102 to make this transparency possible. Once connected to primary site 102, remote site 142 may function as a part of a private network provided by primary site 102.

Network 120 may be a public or private network, such as the Internet, or other communication network to allow connectivity among the various sites 102, 130 to 142 as well as access to servers 160A-B. Network 120 may include third-party telecommunication lines, such as phone lines, broadcast coaxial cable, fiber optic cables, satellite communications, cellular communications, and the like. Network 120 may include any number of intermediate network devices, such as switches, routers, gateways, servers, and/or controllers, which are not directly part of network configuration 100, but that facilitate communication between the various parts of network configuration 100, and between network configuration 100 and other network-connected entities. Servers 160A-B may be, for example, content servers. That is, servers 160A-B may include various providers of multimedia downloadable and/or streaming content, including audio, video, graphical, and/or text content, or any combination thereof, examples of which include web servers, streaming radio and video providers, and cable and satellite television providers. STAs 110A-J, 140A-D, 150A-B may request and access the multimedia content provided by servers 160A-B.

In various examples, systems using RF metamaterials may be implemented in conjunction with other network hardware, such as the various wireless access points 106A, 106B, and 106C of geographical site 102 (similar implementations may be carried out in geographical sites 132 and 142). The RF metamaterials system may use RF metamaterials to receive, transmit, and/or reflect wireless signals in order their propagation. As will be discussed in further detail below, this may include using the RF metamaterials to perform frequency conversion by which RF signals received on a metasurface at a first frequency are re-transmitted therefrom at a second frequency. Additionally, beamforming and beam shaping may also be carried out in order to control a direction of propagation of RF signals, e.g., to direct them so as to increase the signal-to-noise ratio at an end point receiver. It is noted that the various operations carried out using the RF metamaterials of the present disclosure may be combined.

FIG. 2 is a diagram illustrating an example of a system including an RF metamaterial capable of carrying out frequency conversion of received signals. RF metamaterial system 200 as shown in FIG. 2 includes an RF metasurface 201 comprising a number of cells 202. In this particular example, the cells are laid out in a grid, although other arrangements are possible and contemplated.

RF metasurface 201 includes a receiving/reflecting side 204 and a transmitting side 205. RF signals received at the receiving/reflecting side may be re-transmitted from transmitting side in at least one mode of operation, and may be reflected without re-transmission in at least one other mode of operation. As will be discussed in further detail below, each cell 202 includes a first (receiving) antenna on a first surface corresponding to the receiving/reflecting side of RF metasurface 201, and a second (transmitting) antenna on a second surface corresponding to the transmitting side. Using components coupled to these antennas, their respective resonant frequencies may be adjusted to tune their respective frequency responses.

RF metasurface 201 may, in various implementations, carry out frequency conversion. As shown in the example of FIG. 2, incident waves of incoming RF signal 251 may be received on the receiving/reflecting side 204 of RF metasurface at a frequency of f₀ (or angular frequency ω₀). A modulation signal 252 may be received by the various cells 202 of RF metasurface 201, the modulation signal having a frequency of fₘ (angular frequency ωₘ). These two signals may be combined such that incoming RF signal 251 is modulated by modulation signal 252 to generate an outgoing RF signal 253 having a frequency fₜ (angular frequency ωₜ, where ωₜ=ω₀+ωₘ). Accordingly, information initially carried by incoming RF signal 251 may be carried by outgoing RF signal 253 upon modulation and retransmission. RF metasurface 201 may carry out the same or similar to that of a non-linear mixer circuit with less power consumption than that by the latter.

The ability to perform frequency conversion by system 200 as shown in FIG. 2 may allow, for example, the relaying of signals between different frequency bands in a WiFi network. This may further allow the reduction of network congestion within a WiFi network, particularly when a large number of users are consuming portions of particular frequency bands.

A method of operating a system such as system 200 is now described with respect to FIG. 2B. Method 280 as may be carried out by any of the various system implementations disclosed herein. Furthermore, a system capable of carrying out Method 280, but not otherwise discussed herein, is also considered to fall within the scope of this disclosure.

Method 280 includes receiving, at one of a plurality of elements of an RF metasurface, information encoded in a first signal, wherein the first signal is a radio frequency (RF) signal having a first frequency (block 282). The element of the RF metasurface may be one of a plurality of cells, e.g., as shown in FIG. 2A above as well as in other drawings discussed below. In receiving the first signal, a first antenna on a resonant frequency of first surface of the given element may be tuned using, e.g., using PIN diodes.

Method 280 further includes modulating the first signal, and using a modulation signal received by the one of the plurality of elements to generate a second signal. The second signal may have a second frequency different from the first frequency, wherein the second signal is an RF signal encoding the information (block 284). The modulation signal may be generated using any suitable type of modulation signal generation circuit, and may be provided to the cells of the RF metasurface through, e.g., diodes or other appropriate circuitry. The modulation signal, when received at a given cell of the RF metasurface, combines with the first signal to generate the second signal at the second frequency, with the second frequency being dependent on both the first frequency and the frequency of the modulation signal.

The operation is similar to that of an RF mixer in transmitter and receiver circuits that may perform upconversion of signals to be transmitted or downconversion of signals to be received, respectively. However, the power consumed may be significantly less than that of an active mixer that utilizes multiple active circuit components (e.g., transistors) biased in the non-linear region of operation.

Method 280 further includes transmitting the information, using the second signal, from the one of the plurality of elements (block 286). In various implementations, where the first signal is received on an antenna on the first side of the given element of the RF metasurface, the second signal may be transmitted from a second antenna on a second side of the element, the second side being opposite of the first.

In addition to transmitting signals after frequency conversion, the elements of an RF metasurface per the disclosure, may perform beamforming and beam steering. Beamforming may be used to improve signal strength, signal-to-noise ratio, and signal quality at a receiver. Signal range and spectral efficiency may also be improved. Beam steering may allow these improvements to move as the receiver moves through a particular area in which the signals are transmitted.

FIG. 3A is a perspective view of an example RF metamaterial cell used to implement an RF metasurface. In the illustrated example, metamaterial cell 302 includes a receiving antenna 304 on a first surface and a transmitting antenna 305 on a second surface that is opposite the first surface. Frequency control diodes 315 integrated into the first antenna may be used to control the first antenna's resonant frequency. At least one modulation signal diode 316 is present on the first surface and coupled to receiving antenna 304 to provide a signal path for a modulation signal.

The receiving antenna 304 in the example shown is electrically coupled to the transmitting antenna 305 through an interconnection provided by a center conductor 311. Other conductors may be present in some implementations. Mode switches 317 are integrated into transmitting antenna 305, and may be used in selecting an operating mode for an RF metasurface of which metamaterial cell is a part.

The construction of one example of a unit cell is further illustrated in FIG. 3B, which is an exploded view of an example RF metamaterial cell used to implement an RF metasurface. In the illustrated example, RF metamaterial cell 302 is implemented in various layers using different materials. As shown in FIG. 3B, the illustrated unit cell design comprises a plurality of metal layers, as well as multiple layers of a fiberglass-reinforced laminate, FR4 in this particular implementation. Diode control conductors 334 extend vertically through the structure to enable the application of bias voltages to the diodes, while center conductor 311 connects the receiving antenna 304 to transmitting antenna 305.

A first surface (top as shown here) includes the receiving antenna 304 and the PIN diodes 315 integrated therein. The receiving antenna 304 includes different metal portions that may be electrically connected to one another via the PIN diodes 315. The respective sizes and shapes of the metal portions of receiving antenna 304, along with the operation of the PIN diodes 315, may be used to control a resonant frequency of the antenna (as will be explained in further detail below with reference to FIG. 4). A modulation signal diode 316 is also coupled to receiving antenna 304 to enable the input of a modulation signal and thus frequency conversion.

Ground plane 325 is implemented under a FR4 layer 327 to isolate electromagnetic radiation between the receiving antenna and transmitting antenna 305, which is on a second (bottom) surface of the cell 302. Ground plane 325 is connected to transmitting antenna 305 using at least one via hole 336. FR4 layer 328 is disposed underneath ground plan 325, and is the thickest of layers of fiberglass-reinforced laminate. Beneath FR 4 layer 328 (and above FR4 layer 329) are multiple instances of bias line with stub 321, which may be used to apply bias voltages to respective PIN diodes 315 via corresponding diode control conductors 334 (only one of which is labeled here, for the sake of illustration).

Transmitting antenna 305 is implemented on the bottom surface of cell 302 as shown in FIG. 3B. In this non-limiting example, transmitting antenna includes three different metal sections with two mode switch PIN diodes 317 integrated therein. Control of PIN diodes 317 may be used to select one of a plurality of operating modes for cell 302, and thus an RF metasurface in which it is a part. Additional discussion of the structure and operation of transmitting antenna 305 in transmitting signals, along with the operation of PIN diodes 317 in mode selection, is provided below with reference to FIG. 5.

FIG. 4 is a top view of an example of a receiving antenna of an RF metamaterial cell. Receiving antenna 404 may be implemented on the example RF metamaterial cell 302 discussed above with reference to FIGS. 3A and 3B. The shape and the dimensions of the metal portions 431, 432, and 433, along with the operation of PIN diodes 415, may be used to control both a resonant frequency of receiving antenna 404, as well as the mixing operation. This mixing operation can be controlled using a modulation signal to generate, based on a first signal received by receiving antenna 404, a second signal for transmission at a different frequency.

Metal portion 433 of receiving antenna 404 may be referred to as the center metal portion, and has a first dimension W2 along a first axis and a second dimension L2 along a second axis that is perpendicular to the first axis. The two side metal portions, metal portion 431 and metal portion 432, form microstrips that can be used in controlling the tunability of receiving antenna 404. Each of these microstrips has dimensions of W1 on the first axis and L1 on the second axis. Metal portion 431 is separated from metal portion 433 by a first separation distance S1. Metal portion 432 is separated from metal portion 433 by a second separation distance S2, which is less than S1. Tunability of receiving 404 is dependent on these dimensions, and is now discussed in further detail.

Frequency tunability of receiving antenna 404 (and thus, a corresponding unit cell) may be achieved using the PIN diodes 415. By applying a reverse bias voltage to a given one of PIN diodes 415, the center patch of the antenna, metal portion 433, is effectively connected with a corresponding one of the side microstrips formed by metal portion 431 or metal portion 432 to form an H-shape antenna structure. A given one of the PIN diodes 415 may be considered to be turned on when a reverse bias voltage is applied thereto. When this occurs, the selected PIN diode 415 acts as a coupling capacitor at a particular frequency, depending on the level of reverse bias voltage applied thereto. A given one of the PIN diodes 415 may be considered to be turned off when no bias voltage is applied thereto, and may thus operate as a resistor.

If only one of the PIN diodes 415 is turned on, the incident waves form an unbalanced electric field, creating a non-uniform current flow. This results in perturbation of surface impedance across frequencies. The H-shaped patch will couple with the other microstrip whose diode is off, lengthening the effective dimensions and lowering its resonant frequency. For example, if the PIN diode 415 coupled between metal portion 431 and metal portion 433 is turned on while the other PIN diode 415 is turned off, the H-shaped patch formed by metal portion 415 and metal portion 433 will couple with metal portion 432 and thus lower the resonant frequency of receiving antenna 404.

Therefore, frequency tunability for receiving antenna 404 is achieved by controlling the effective dimensions of the microstrips formed by metal portions 431 and 432 and the center metal portion 433 when the different PIN diodes are turned on. More simply put, the resonant frequency of the receiving antenna 404 may be controlled by controlling the effective length and width of the antenna. In this manner, the illustrated example achieves 2-bit control to provide four different configurations to cover a particular bandwidth range. Table 1 below illustrates an example of effective widths, length, and center frequencies achievable using 2-bit control in one non-limiting implementation:

TABLE 1

| Diode Control | | | Estimated |
|---|---|---|---|
| Code (1 = ON, | Effective | Effective | Center |
| 0 = OFF) | Width | Length | Frequency |
| 0 0 | W2 | L2 | 5.6 GHz |
| 0 1 | W1 | L2 + S2 + L1 | 4 GHz |
| 1 0 | W1 | L1 + S1 + L2 | 4.5 GHz |
| 1 1 | W1 | 2L1 + L2 + S1 + S2 | 3.4 GHz |

To perform a frequency conversion, a unit cell using an implementation of receiving antenna 404 adopts time as an additional degree of freedom. In particular, space-time modulation of the microstrips (metal portions 431 and 432) is leveraged to achieve the desired mixing of the received (incident) signal and the modulation signal. Space-time modulation simultaneously alters both amplitude and phase of signals within the cells by controlling the bias voltages on with a time-varying magnitude and frequency at modulation signal diode 416, which is a grounded PIN diode in this example. This additional diode on receiving antenna 404 mixes the incident signals with the input modulation signal. The mixing may produce a transmission signal with a frequency ωₜ based on the frequency of the incident signal ω₀ and a frequency of the modulation signal ωₘ such that ωₜ=ω₀+ωₘ. The modulation signal may be provided by a voltage controlled oscillator (VCO), which may be digitally programmable in some implementations and may use a multi-way power divider to provide a plurality of cells of an RF metasurface with equal voltages of the modulation signal.

FIG. 5 is a bottom view of an example RF metamaterial cell. More particularly, FIG. 5 illustrates an example of a transmitting antenna 505. The overall dimensions of transmitting antenna are L3 along a first axis and W3 along a second axis perpendicular to the first axis. Transmitting antenna 505 includes three different metal portions, outer metal portion 511, outer metal portion 512, and center metal portion 513. A first PIN diode 519 is coupled between outer metal portion 511 and center metal portion 513. A second PIN diode 519 is coupled between outer metal portion 512 and center metal portion 513. These first and second PIN diodes 519 may be used for both mode switching as well as for phase control that enables beamforming. The shape of the various metal portions forms what is referred to as an O-slot ring, or O-slot resonator.

Mode switching and phase control may be achieved by the structure described above by altering the direction of current flow. The symmetric pair of PIN diodes 519 may determine the phase and operating mode by blocking/allowing current flow captures by the corresponding receiving antenna into the O-slot resonator. If only one of PIN diodes 519 is switched on (e.g., forward biased), there are two current distributions having opposite directions within outer metal portions 511 and 512. This opposite current direction flow indicates a phase difference in the signals radiated from one outer metal portion of the antenna and the other. This property may be used in beamforming radiated signals. If neither of the PIN diodes 519 is switched on, only a minimum amount of current will leak through, and thus signal power radiated transmitting antenna 505 may be very small. When both PIN diodes 519 are switched off, the corresponding cell operates in a reflection mode, since the radiated signal power is very small, and thus a second signal is effectively inhibited from transmission. Otherwise, when at least one of PIN diodes 519 is on, the corresponding cell operates in a transmitting mode.

Using the ability to control the phase difference between signals radiated from the outside portions of the transmitting antenna 505 based on respective states of the various diodes may enable beamforming and beam steering in an RF metasurface comprising a plurality of cells. The respective phases of transmitted signals may be controlled among the plurality of cells such that the signals transmitted therefrom constructively interfere (e.g., are additive in amplitude) in a desired direction, while the phase difference may cancel or reduce signal amplitude in other directions. The size of the beams may vary from one implementation to another, and may be affected by the size of individual cells as well as the spacing between the cells.

It is further possible and contemplated that, during beamforming operations, only a subset of the plurality of cells (vs. using all cells of the RF metasurface) may be active to carry out the beamforming operations. This may be used in various applications, such as multipath/MIMO (Multiple Input, Multiple Output) applications, partial beam steering and sector based control, adaptive beam shaping, and so on.

FIGS. 6A-6D are drawings illustrating different possible operating modes for an example RF metamaterial cell. An RF metasurface using the cells of the disclosure may operate in a reflection mode or a transmission mode. FIG. 6A illustrates operation in the reflection mode. In the reflection mode, the receiving antenna 604 reflects an incident signal, while no substantial signal is transmitted from the transmitting antenna 605. While some signal may be radiated from the transmitting antenna 605, such a signal may be of minimal power such that it may be difficult or impossible to detect by a receiver nearby. The reflection mode may be entered by switching the PIN diodes of the transmitting antenna off (e.g., not forward biased) such that no more than a small amount of leakage current passes from the center metal portion to the outer metal portions. This in turn significantly reduces the power of any signal that might otherwise be radiated from the transmitting antenna 605.

FIG. 6B illustrates the basic transmission mode. In the transmission mode, one of the PIN diodes 619 associated with the transmitting antenna 605 is on, thereby allowing current to pass from the center metal portion to one of the outer metal portions, per the discussion above with reference to FIG. 5. Accordingly, a signal may be transmitted from the transmitting antenna at power levels sufficient for receiving by receivers within range of the antenna. It is noted that the receiving antenna may still reflect at least a portion of the incident signal in this mode.

FIG. 6C further illustrates the control of a resonant frequency of receiving antenna 604, which may occur in either the reflecting or transmitting modes. The resonant frequency of the selective control of the PIN diodes 615 to connect or disconnect metal portions 631 and 632 to metal portion 633, and thus to vary the effective dimensions of receiving antenna 604. As shown in the example of Table 1 above, both PIN diodes of the transmitting antenna 605 may be turned off, turned on, or one of the two may be turned on to achieve a desired resonant frequency. Further control of the resonant frequency may be achieved through application of bias voltages to the bias stubs shown in FIG. 3. Since the resonant frequency is dependent on the effective dimensions of the receiving antenna, the disclosure contemplates various implementations of unit cells with the actual sizes and separation of the various antenna portions are selected in accordance with a desired frequency response.

FIG. 6D further illustrates operation in the transmission mode with frequency conversion. In this mode of operations, a modulation signal is input into the receiving antenna and combined with the incident signal to produce the transmitted signal. The frequency of the transmitted signal is dependent on the respective frequencies of the modulation signal and the incident signal. Control of the frequency of the second signal may be further based on the state of the various diodes of the unit cells and the amplitude of various bias voltages that may also be applied.

FIG. 7 is a perspective view illustrating an example system including an RF metamaterial and a modulation signal generator. In the illustrated example, RF metasurface 701 includes a plurality of cells 702. In this non-limiting implementation, the cells are arranged in a grid, although other arrangements are possible and contemplated.

The illustrated system further includes a modulation signal generator circuit 735 and a mode control circuit 740. The modulation signal generator circuit 735 may comprise, e.g., a digitally-controlled VCO configured to distribute a modulation signal to each of the cells 702 (or selected cells) during operation. Modulation signal generator circuit 735 may control both the frequency and the amplitude of the generated modulation signal such that it is received at the desired power and frequency by the various cells 702.

Mode control circuit 740 in the illustrated example may generate bias voltages that are applied to the various diodes in each of the cells 702, which may include bias voltages provided to bias stubs. In a given operational configuration, mode control circuit 740 may apply the same voltages to all cells 702, while in another operational configuration, different voltages may be applied to selected ones of the cells. Mode control circuit 740 may further select an operational mode for RF metasurface 701 and the cells 702 thereof, such as the reflecting and transmitting modes discussed above, as well as selecting a resonant frequency of the receiving antenna for the various cells 702.

It is noted that in some implementations, modulation signal generator 735 and mode control circuit 740 may be included in the same unit, e.g., within a computer system communicatively coupled to RF metasurface 701.

FIGS. 8A-8C are illustrations of example use cases for an RF metamaterial system according to the disclosure. In FIG. 8A, an instance of RF metasurface 801 is used for coverage extension to provide wireless coverage to User 1 from a wireless access point AP1, where the device of User 1 might otherwise be blocked or limited from receiving coverage from that access point. A different user in this example, User 2, is receiving coverage from a second access point AP2. To avoid interference in the same frequency band, RF metasurface 801 may carry out frequency conversion per the disclosure such that the devices of User 1 and User 2 operate using different frequency bands. This may reduce or eliminate interference in the vicinity of the devices of User 1 and User 2 while enabling both to operate with good wireless connections.

In FIG. 8B, a spectrum sensing application is being utilized using RF metasurface 801. In this example, a narrowband sensor of an access point transmits a signal having a frequency fₙ to RF metasurface 801, which in turn (using the frequency conversion capabilities) generates multiple signals with frequencies f₁-fₖ. Another access point in this scenario is using frequency f₂. Accordingly, using the spectrum sensing, the narrowband sensor may determine that the band corresponding to f₂ is occupied while the bands corresponding to f₁ and f₃-fₖ are not occupied. When a new device enters the area, one of the unoccupied frequency bands may be assigned thereto.

In FIG. 8C, the motion of a user is tracked. A single access point AP1 transmits a signal to RF metasurfaces 801A and 801B. RF metasurface 801A in this example is operating in the transmission mode, and thus relays a signal to a mobile user moving through the area. The frequency of the signal relayed from RF metasurface 801A may have a different frequency than the signal transmitted from access point AP1. RF metasurface 801B in this example is operating in the reflection mode. The device of the mobile user may further respond to the signals, relaying information back to the access point. As the user moves closer to RF metasurface 801B, the time-of-flight of the signals change. Using information regarding the changing time-of-flight, access point AP1 may track the motion of the mobile user's device through the area.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain examples include, while other examples do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. An apparatus comprising:
a radio frequency (RF) metasurface element, wherein the RF metasurface element includes:
a first antenna on a first surface;
a second antenna on a second surface facing a direction opposite that of the first surface; and
a modulation signal input;
wherein the RF metasurface element is configured to:
receive, at the first antenna, a first electromagnetic signal having a first frequency;
receive, at the modulation signal input, a modulation signal; and
transmit, from the second antenna, a second electromagnetic signal corresponding to the first electromagnetic signal, the second electromagnetic signal having a second frequency different from the first frequency and dependent on the first frequency and a frequency of the modulation signal.

2. The apparatus of claim 1, wherein the first antenna comprises a first metal portion, a second metal portion, and a third metal portion, wherein the first and second metal portions are selectively connectable to the third metal portion.

3. The apparatus of claim 2, further comprising a first PIN diode coupled between the first metal portion and the third metal portion, and a second PIN diode coupled between the second metal portion and the third metal portion, wherein the first and second PIN diodes are configured to connect the first and second metal portions, respectively, to the third metal portion in response to application of a reverse bias voltage.

4. The apparatus of claim 3, wherein a resonant frequency of the first antenna is tunable based on which of the first and second PIN diodes have a bias voltage applied thereto.

5. The apparatus of claim 3, wherein the second antenna comprises a center metal portion, a first outer metal portion, and a second outer metal portion, wherein in the first and second outer metal portions are coupled to the center metal portion by third and fourth PIN diodes, respectively.

6. The apparatus of claim 5, wherein the RF metasurface element is configured to transmit the second electromagnetic signal when operating in a transmission mode, wherein, when operating in the transmission mode, at least one of the third and fourth PIN diodes is forward biased, and wherein the RF metasurface is further configured to operate in a reflection mode in which neither of the third or fourth PIN diodes is forward biased, and wherein, when operating in the reflection mode, the second electromagnetic signal is inhibited from transmission from the second antenna.

7. The apparatus of claim 5, wherein the RF metasurface element is tunable with respect to first frequency and the second frequency depending on respective states of the first, second, third and fourth PIN diodes.

8. The apparatus of claim 2, wherein the RF metasurface element further comprises an interconnection via coupled between the third metal portion and the second antenna.

9. The apparatus of claim 1, wherein the RF metasurface element further comprises a modulation signal diode coupled between the modulation signal input and the first antenna.

10. The apparatus of claim 1, wherein the RF metasurface element further comprises a ground plane and a plurality of layers of fiberglass-reinforced laminate arranged between the first and second antennas.

11. A method comprising:
receiving, at one of a plurality of elements of an RF metasurface, information encoded in a first signal, wherein the first signal is a radio frequency (RF) signal having a first frequency;
modulating the first signal, using a modulation signal received by the one of the plurality of elements, to generate a second signal, the second signal having a second frequency different from the first frequency, wherein the second signal is an RF signal encoding the information; and
transmitting the information, using the second signal, from the one of the plurality of elements.

12. The method of claim 11, further comprising receiving the first signal at a first antenna implemented on a first surface of the one of the plurality of elements and transmitting the second signal from a second antenna on a second surface of the one of the plurality of elements, wherein the second signal is opposite the first surface.

13. The method of claim 12, further comprising:
tuning, using first and second PIN diodes of the one of the plurality of elements, a first resonant frequency associated with the first antenna; and
tuning, using third and fourth PIN diodes of the one of the plurality of elements, second resonant frequency associated with the second antenna.

14. The method of claim 13, further comprising:
transmitting, from ones of at least a subset of the plurality of elements, a beam comprising the second signal; and
steering the beam using PIN diodes of the ones of the at least the subset of the plurality of elements.

15. The method of claim 11, further comprising:
operating the one of the plurality of elements in a transmission mode, wherein operating in the transmission mode comprises transmitting the second signal from the one of the plurality of elements; and
operating the one of the plurality of elements in a reflection mode, wherein operating in the reflection mode comprises inhibiting transmitting the second signal from the one of the plurality of elements.

16. A system comprising:
a signal generation circuit configured to generate a modulation signal; and
a radio frequency (RF) metasurface comprising a plurality of elements, wherein ones of the plurality of elements include a modulation signal input coupled to receive the modulation signal, and wherein a given one of the plurality of elements includes:
a first antenna on a first surface; and
a second antenna on a second surface facing a direction opposite that of the first surface;
wherein the RF metasurface is configured to, when operating in a transmission mode:
receive, at the first antenna of ones of the plurality of elements, a first RF signal having a first frequency; and
transmit, from the second antenna of the ones of the plurality of elements, a second RF signal having a second frequency different from the first frequency, wherein the second frequency is dependent on the first frequency and a frequency of the modulation signal.

17. The system of claim 16, wherein ones of the plurality of elements include:
first and second PIN diodes associated with the first antenna; and
third and fourth PIN diodes associated with the second antenna;
wherein respective resonant frequencies of the first and second antennas are adjustable using the first, second, third and fourth PIN diodes.

18. The system of claim 17, wherein the RF metasurface is further configured to operate in a reflection mode based on biasing of the third and fourth PIN diodes of ones of the plurality of elements, wherein, during operation in the reflection mode, the second antenna the ones of the plurality of elements is inhibited from transmitting the second RF signal.

19. The system of claim 17, wherein the RF metasurface is configured to steer a beam of the second RF signal based on respective states of the first, second, third and fourth PIN diodes of the ones of the plurality of elements.

20. The system of claim 16, wherein the given one of the plurality of elements further includes a conductor coupled between the first antenna and the second antenna.
